(19) United States
(12) Patent Application Publication
(10) Pub. No.: US 2022/0338489 A1
(43) Pub. Date: Oct. 27, 2022

(54) METHOD FOR PRODUCING A CONCAVE BAKERY PRODUCT HAVING A DESIRED SHAPE

(71) Applicant: Elisabetta Corneo, Milano (IT)

(72) Inventor: Elisabetta Corneo, Milano (IT)

(21) Appl. No.: 17/713,962

(22) Filed: Apr. 5, 2022

(30) Foreign Application Priority Data
Apr. 23, 2021 (IT) 102021000010358
Apr. 30, 2021 (IT) 102021000011078

(51) Int. Cl. A21D 13/80; A21D 8/08

(52) U.S. Cl. CPC A21D 13/80; A21D 8/08

(57) ABSTRACT

A method for producing a bakery product (10) comprising the steps of:
forming a strip-shaped assembly (12, 15, 16, 32) comprising a strip of flour-based dough (13) and a corresponding strip of foldable sheet (14) adhering to the strip of dough; wherein the flour-based dough is suitable to harden after baking;
folding and positioning the strip-shaped assembly (12, 15, 16, 32) on a base so that, at least at a portion of the strip-shaped assembly, the strip-shaped assembly forms an angle in the range of 70 degrees-110 degrees with the base;
heating in an oven the base and the strip-shaped assembly positioned on the base until the flour-based dough hardens;
removing the strip of foldable sheet (14) from the strip-shaped assembly (12, 15, 16, 32) after heating in the oven.

### FIELD OF INVENTION

The present invention relates to a method of generating a concave bakery product having any desired shape.

### BACKGROUND OF THE INVENTION

According to conventional techniques, it is known to bake bakery products, such as cakes or various pastry products. Among the various doughs used in the field of pastry, shortcrust pastry provides some mechanical strength after baking, as the dough hardens after being passed in the oven.

It is also known to make concave bakery products, for example by applying a layer of dough (such as shortcrust pastry) inside a baking tray provided with a flat bottom and side edges which are substantially vertical or, however, raised compared to the flat bottom.

Often, with these types of molds, during baking, the edge undergoes a deformation compared to its original raw shape.

According to a further known technique, in order to obtain concave shapes in shortcrust pastry, micro-perforated molds have been proposed, in this case the deformations of the edge are very limited and the latter turns up to be much more defined. However, at present, when a desired shape is to be made, a corresponding mold has to be available. To date, there is no way to make the edge of any shape without the use of molds.

### SUMMARY OF THE INVENTION

An object of the present invention is to overcome the problems related to the known techniques discussed above. In particular, the object of the present invention is to make concave bakery products having a precisely predetermined shape. A further object of the invention is to provide a method that allows a variety of concave bakery products with any edge shape to be quickly and inexpensively made.

In view of the above objects, the invention provides a method for producing a bakery product comprising the steps of:
forming a strip-shaped assembly comprising a strip of flour-based dough and a corresponding strip of foldable sheet adhering to the strip of dough; wherein the flour-based dough is suitable to harden after baking;
folding and positioning the strip-shaped assembly on a base so that, at least at a portion of the strip-shaped assembly, the strip-shaped assembly forms an angle in the range of 70 degrees-110 degrees with the base;
heating in an oven the base and the strip-shaped assembly positioned on the base until the flour-based dough hardens;
removing the strip of foldable sheet from the strip-shaped assembly after heating in the oven.

In a preferred embodiment, the step of forming a strip-shaped assembly comprises:
applying a layer of a flour-based dough to a foldable sheet;
cutting the foldable sheet and the dough applied thereto to form the strip-shaped assembly.
In a preferred embodiment, the base comprises a substantially planar base of flour-based dough, wherein after the step of positioning the strip-shaped assembly on the base, a lateral edge of the strip-shaped assembly is joined to the base of flour-based dough, preferably along an edge of the base of flour-based dough.

The invention provides a method for producing a concave bakery product comprising the steps of:
applying a layer of a flour-based dough to a foldable sheet, wherein the flour-based dough is suitable to harden after baking; wherein said foldable sheet is suitable to withstand a baking process capable of hardening the dough layer;
cutting the foldable sheet and the dough applied thereto to form a strip-shaped assembly comprising a strip of dough and a corresponding strip of foldable sheet adhering to the strip of dough;
forming a substantially planar base of flour-based dough;
folding and positioning the strip-shaped assembly along an edge of the base so that, at least at a portion of the strip-shaped assembly, the strip-shaped assembly forms an angle in the range of 70 degrees-110 degrees with the base and so that a side edge of the strip-shaped assembly is joined to the base edge;
heating in an oven the base and the strip-shaped assembly that is positioned along the edge of the base until the flour-based dough hardens;
removing the strip of foldable sheet from the strip-shaped assembly after heating in the oven.

This way, thanks to the versatility of the arrangement of the strip-shaped assembly consisting of the strip of foldable sheet and the strip of dough, various shapes of the concave bakery product can be obtained. In particular, during baking, the foldable sheet helps to hold the strip of dough arranged at the edge of the base in a desired substantially vertical position.

According to a preferred embodiment, before applying the layer of dough on the foldable sheet, the method comprises the step of piercing or embossing the foldable sheet, or the foldable sheet used in the method is perforated, and/or the foldable sheet is embossed. These measures improve the adhesion of the dough layer to the strip of sheet during baking.

According to a preferred embodiment, the density of the holes in the foldable sheet is in the range of 10 to 60 holes per cm2, wherein the diameter of the holes is less than or equal to 1.5 mm. According to this arrangement, the foldable sheet holds the dough in a desired position during baking, thus preventing the dough from slipping.

According to a preferred embodiment, the strip-shaped assembly has a strip width between 1 cm and 5 cm, preferably between 2 cm and 4 cm. This way, a concave bakery product with a desired predetermined shape and sufficient volume inside the concavity formed by the product itself can be obtained.

According to a preferred embodiment, the dough layer applied to the foldable sheet has a thickness between 2 mm and 5 mm.

According to a preferred embodiment, said dough base comprises at least one curved edge, characterized in that, in the edge segments with a radius of curvature greater than 5 cm and longitudinal extension greater than 7 cm, a supporting element with a substantially L-shaped profile is applied to the strip-shaped assembly before heating in order to support the strip-shaped assembly in a position inclined substantially by 90-degree with respect to the base during the heating step, and/or further characterized in that the strip-shaped assembly is not supported by any supporting element during the heating step at edges of the base with a radius of curvature of less than 5 cm. This allows the dough to be easily and smoothly held in a desired position during baking with any shape of the edge of the dough base. However, the edges can also be a set of straight segments and take the shape of a star, for example.

According to a preferred embodiment, the step of cutting the foldable sheet and the dough applied thereto comprises:
cutting the dough and the underneath aluminum sheet by incising them with a cutting blade according to a desired width. If necessary, in order to precisely cut the sheet of shortcrust pastry and aluminum into strips, it can be cooled for 3 minutes at a temperature below 0° C. and then the overturned sheet can be cut into strips. In that case, the strips should return to a temperature of about 20° so that they recover their bendability and can be easily made to adhere to any shape of the base.

According to a preferred embodiment, before applying the dough layer to the foldable sheet, a layer of egg white is applied to the foldable sheet so that, after applying the dough layer, the egg white layer is interposed between the foldable sheet and the dough layer. This allows the adhesion of the dough to the foldable sheet to be improved, especially during baking, thus enabling to obtain a precise desired shape of the concave bakery product.

Preferably, the foldable sheet is made of aluminum or of paper suitable for baking. This allows the strip-shaped assembly to be made from readily available and inexpensive materials.

The invention further provides a foldable sheet intended to support a flour-based dough during baking, said sheet having a width between 4 cm and 50 cm and being microperforated, wherein the density of the holes in the foldable sheet is in the range from 10 to 60 holes per cm2, and wherein the holes have diameter less than or equal to 1.5 mm. This previously perforated sheet allows the strip-shaped assembly comprising a strip of dough and a strip of foldable sheet to be quickly and easily made according to the method described above.

### BRIEF DESCRIPTION OF THE SEVERAL VIEWS OF THE DRAWINGS

FIG. 1 shows a bakery product made by the method according to the invention.

FIG. 2 shows a bakery product made by a variant of the method according to the invention.

FIGS. 3-4 show views of the strip-shaped assembly and the assembling of the strip-shaped assembly to the base in the embodiment of FIG. 2; in particular, FIG. 4 is a cross-sectional view showing the base and the strip-shaped assembly according to a variant of the invention.

FIG. 5 shows a further variant of the strip-shaped assembly and its assembling to the base in a cross-sectional view.

### DETAILED DESCRIPTION

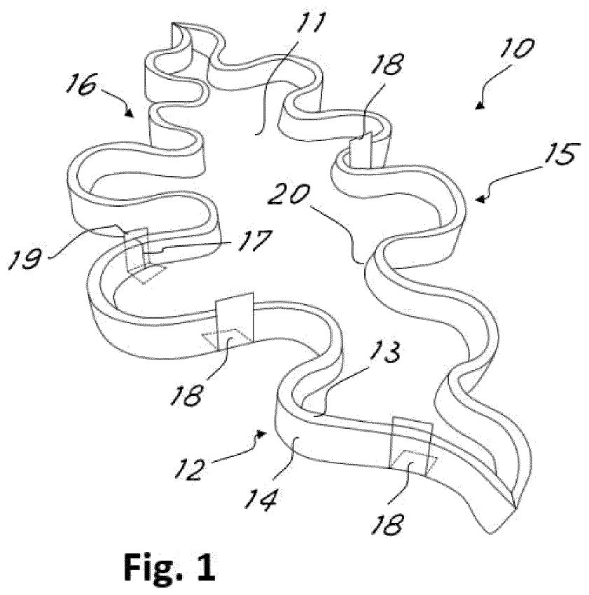

FIG. 1 shows a concave bakery product 10 obtained according to the invention in a step after baking in an oven. The concave bakery product 10 comprises a substantially planar base 11 and a substantially vertical wall formed at a dough strip that is joined to a peripheral edge of the base 11. Advantageously, the vertical wall runs along the entire periphery 20 of the base 11 so as to form a planarly-extending concave space arranged above the base 11.

The method for producing the product 10 of FIG. 1 provides the following steps 1) to 7).

1) Applying a layer of a flour-based dough to a foldable sheet, wherein the flour-based dough is suitable to harden after baking. Preferably, the foldable sheet is made of aluminum or paper suitable for baking; however, other materials could also be used, as long as they can withstand a baking process capable of hardening the dough. The flour-based dough is advantageously a shortcrust pastry. For example, the following composition could be used for the shortcrust pastry dough:
flour between 30% and 70% by weight to the total,
butter between 10% and 40% by weight to the total,
sugar between 5% and 35% by weight to the total,
eggs between 4% and 12% by weight to the total.

More preferably, the following composition could be advantageously used for the shortcrust pastry dough:
flour between 40% and 60% by weight to the total,
butter between 20% and 30% by weight to the total,
sugar between 15% and 25% by weight to the total,
eggs between 6% and 10% by weight to the total.

Even more preferably, the composition is about 50% by weight of flour, about 25% by weight of butter, about 20% by weight of sugar, about 5-7% by weight of egg yolk and about 1% by weight of egg white.

Advantageously, at this step the dough is rolled out on the foldable sheet to a thickness between 2 mm and 5 mm.

According to a preferred embodiment, before applying the layer of dough on the foldable sheet, the method comprises the step of embossing or piercing the foldable sheet; as an alternative, the foldable sheet used in the method is perforated in advance since a micro-perforated foldable sheet has been purchased for this purpose. Preferably, the density of the holes in the foldable sheet is in the range of 10 to 60 holes per cm2, (preferably in the range between 20 and 60 holes per cm2), wherein the diameter of the holes is less than or equal to 1.5 mm. As an alternative, the foldable sheet is embossed, i.e. provided with a rough surface suitable for adhering to the dough. In particular, it has been found that perforating the foldable sheet is particularly advantageous when using a foldable sheet made of paper, such as baking paper. Embossing has proven to be particularly advantageous in case the foldable sheet is an aluminum sheet. Preferably, the thickness of the foldable sheet is less than 20 μm, preferably less than 10 μm. The folding sheet may also be neither perforated nor embossed.

In addition, preferably, before applying the dough layer to the foldable sheet, a layer of egg white is applied to the foldable sheet so that, after applying the dough layer, the egg white layer is interposed between the foldable sheet and the dough layer.

2) Cutting the foldable sheet and the dough applied thereto to form a strip-shaped assembly 12 comprising a strip of dough 13 and a corresponding strip of foldable sheet 14 adhering to the strip of dough. In this step, according to an alternative, the foldable sheet may also have been cut into a strip shape before the dough is applied to the foldable sheet. FIG. 1 shows three strip-shaped assemblies 12, 15 and 16 already folded and applied to the base 11, although freshly cut assemblies 12, 15 and 16 may also have a different shape, for example being arranged on a work surface. Each strip-shaped assembly 12, 15 and 16 comprises a strip of dough and a strip of foldable sheet adhering thereto. Preferably, the strip-shaped assembly 12 has a strip width between 1 cm and 5 cm, preferably between 2 cm and 4 cm. The same may be valid for the other strip-shaped assemblies 15 and 16 used to make a given concave bakery product 10. Advantageously, the strip-shaped assembly 12, 15, 16 has a substantially constant width along its longitudinal extent, as in the example shown in the figure; however, according to a variant of the invention, the strip-shaped assembly could also have a width variable along its longitudinal extent.

Advantageously, the strip-shaped assembly 12, 15, 16, when freshly formed as a result of cutting on a work surface, has substantially rectilinear longitudinal extent; however, in a variation of the invention, the strip-shaped assembly 12, 15, 16 could also have a non-rectilinear axis.

According to a preferred embodiment, the step of cutting the foldable sheet and the dough applied thereto comprises:
cutting the dough and the underneath foldable sheet by incising them with a cutting blade according to a desired width. If necessary, in order to precisely cut the sheet of shortcrust pastry and aluminum into strips, it can be cooled for 3 minutes at a temperature below 0° C. and then the overturned sheet can be cut into strips.

3) Forming a substantially planar base 11 of flour-based dough. Said dough base 11 may have any desired shape and, for example, may comprise at least one curved edge as shown in FIG. 1. Advantageously, the base 11 is formed from the same dough used to make the dough strips of the assemblies 12, 15 and 16. This step could also be carried out before steps 1) and 2). In addition, this step 3) could also be omitted altogether; in that case, any base suitable to withstand the baking process, such as a baking tray, could be used as a base to support the strip-shaped assembly. The dough base 11 could have a thickness of about 2 mm-6 mm, preferably in the range of 3 mm-6 mm.

4) Folding and positioning the strip-shaped assembly 12, 15 and 16 along an edge 20 of the base, so that the strip-shaped assembly forms a substantially 90 degree angle with the base and so that a side edge of the strip-shaped assembly is joined to the edge 20 of the base 11. In the variant in which no dough base is formed, the strip-shaped assembly can be folded and placed on a base such as a baking tray. According to a further alternative, the strip-shaped assembly could also be placed on the dough base 11 but not along an edge thereof, for example in the middle of the base 11. “Substantially 90 degrees” is meant herein also angles that differ from exactly 90 degrees, such as angles in a range between 70 and 110 degrees, preferably between 80 degrees and 100 degrees, or between 85 and 95 degrees. The strip-shaped assembly 12, 15, 16 could be applied so that all of it or a portion thereof, i.e., not its entire longitudinal extent, form a substantially 90-degree angle with the base 11. In a variation of the invention, the inclination between the strip-shaped assembly 12, 15 and 16 and the base 11 could vary along the longitudinal extent axis of the strip-shaped assembly. In some places, the strip-shaped assembly 12, 15, 16 could also be inclined by an angle that is not substantially 90 degrees, i.e., outside the 70-90 degree range. By the way, at least one portion of the longitudinal extent of the strip-shaped assembly is substantially orthogonal to the base 11, i.e., forms a substantially 90-degree angle as described above. In a preferred embodiment, as shown in FIG. 1, the strip-shaped assembly is applied to the edge of the base 11 so as to form a substantially 90-degree angle along all the longitudinal extent of the strip-shaped assembly. In a preferred embodiment, in at least one place, the strip-shaped assembly is inclined by 90 degrees with respect to the base. After applying the strip-shaped assembly 12 to the base 11, the foldable sheet 14 remains arranged outwardly of the product 10. The same is valid for the other assemblies 15 and 16.

In the example shown in figure, three strip-shaped assemblies 12, 15, and 16 are sequentially arranged along the edge 20 of the base 11 so as to be adjacent to each other; anyway, a different number of strip-shaped assemblies could also be provided, even one or more than three.

Preferably, in the segments of the edge 20 of the base 11 with radius of curvature greater than 5 cm and longitudinal extent greater than 7 cm, a supporting element having a substantially L-shaped profile 18 (or T-shaped or other equivalent shape suitable for resting steadily on a supporting flat surface and adhering to the strip-shaped assembly) is applied to the strip-shaped assembly before heating, in order to support the strip-shaped assembly at a substantially 90-degree inclined position with respect to the base during the heating step. Conversely, at edges of the base 11 with radius of curvature of less than 5 cm, the strip-shaped assembly 12, 15 and 16 is not supported by any supporting element during the heating step. The L-shaped supports can also be advantageously placed at the joints 17 between one strip of dough and aluminum and another when these are on the same line or a continuous curve (thus not at points where the adjacent strip-shaped assemblies are arranged to form a corner or broken line, no L-shaped supporting element is provided, see the point between the assembly 15 and the assembly 16 or the point between the assembly 12 and the assembly 15). For example, the L-shaped supporting element 18 is positioned at the joint 17 between the strip-shaped assembly 12 and the adjacent one 16 along the edge 20 of the base 11. The L-shaped support may be formed from a folded aluminum plate having thickness greater than the foldable sheet 14. A leg of the L-shaped support 18 may be arranged below the base 11 during baking, whereas the vertical leg of the L-shaped support 18 may be arranged adjacent to the assembly 12, 15 or 16 to be supported. In this step, after applying the L-shaped supports to the strip assembly 12, 15, 16 or after positioning the strip assembly in a substantially vertical position with respect to the base 11, an additional strip of foldable sheet (e.g., of aluminum) may be applied to the strip assembly 12, 15, 16 on the dough side. The additional strip of foldable sheet is preferably applied to a substantially rectilinear length of the strip-shaped assembly in order to increase its stability. Additional L-shaped supports arranged with a horizontal bottom portion that rests on the base 11 and the substantially vertical portion adhering to the strip-shaped assembly, may also be provided.

5) Preferably, cooling the manufactured item for 15 minutes at a temperature below 0° C. before placing it in the oven. This is an optional step.

6) Heating in an oven the base and the strip-shaped assembly that is positioned along the edge of the base until the flour-based dough hardens. After placing the strip-shaped assemblies 12, 15 and 16 as shown in FIG. 1 along the edge of the base 11, the bakery product can be baked in the oven until hardened.

7) Removing the strip of foldable sheet 14 from the strip-shaped assembly 12, 15, 16 after heating in the oven. The bakery product is then ready to be tasted or to be stuffed by filling its cavity.

According to the invention a foldable sheet intended to support a flour-based dough during baking is further provided, said sheet having a width between 4 cm and 50 cm and being micro-perforated, wherein the density of the holes in the foldable sheet is in the range from 10 to 60 holes per cm2 (preferably between 20 and 60 holes per cm2), and wherein the holes have diameter less than or equal to 1.5 mm. Since a micro-perforated sheet that is particularly suitable for holding the dough in position, even vertically, during baking is available from the beginning, this sheet allows the step 1) of the method to be easily carried out. Preferably, the foldable sheet is more than 10 cm long, even more preferably more than 20 cm long, or more than 30 cm long. Preferably, the foldable sheet has a thickness of less than 20 μm, preferably less than 10 μm.

The strip-shaped assembly 12, 15, 16 is preferably more than 10 cm long, even more preferably more than 20 cm long, or more than 30 cm long.

Preferably, the strip-shaped assembly 12, 15, 16 is joined to a non-rectilinear part of the edge of the base 11; more preferably, the strip-shaped assembly is joined to the part of the base edge that comprises at least one curved portion, such as a curved portion whose radius of curvature is less than 5 cm. In an embodiment, the part of the edge 20 of the base 11 to which the strip-shaped assembly is joined comprises at least one wavy portion. The strip-shaped assembly 12, 15, 16 is joined to the edge of the base 11 continuously along its side edge, such that the dough layer of the strip-shaped assembly is adjacent and contiguous to the base.

Where the dough base 11 is absent, the strip-shaped assembly is folded and positioned on the base in a non-rectilinear manner; more preferably, when folded and positioned on the base, the strip-shaped assembly comprises at least one curved portion, such as a curved portion whose radius of curvature is less than 5 cm. In an embodiment, when folded and positioned on the base, the strip-shaped assembly comprises at least one wavy portion.

In the present disclosure it is understood that, before being heated in the oven, the flour-based dough is in a raw malleable state. The dough used to make the base 11 is preferably the same dough used to make the strip-shaped assembly 12, 15, 16; however, different doughs may possibly also be used. Preferably, in the steps of the method according to the invention, the base 11 is supported in a substantially horizontal position, while the at least one strip-shaped assembly 12, 15, 16 is in a substantially vertical position after having been positioned along the side edge of the base 11.

Preferably, the foldable sheet is made so that it can be folded plastically, i.e., non-elastically. This allows the strip-shaped assembly 12, 15, 16 to be easily applied along the edge of the base 11 so that the strip-shaped assembly properly holds its position even during the heating process in the oven.

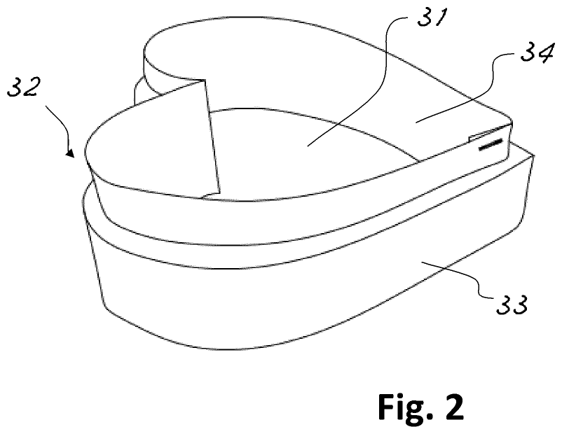

An alternative embodiment of the method according to the invention is shown in FIGS. 2 to 4. In the following, only the differences from the method described above with reference to FIG. 1 are described, without repeating steps that are identical.

In the case of FIGS. 2-4, when the strip-shaped assembly is positioned along the edge of the base 31, the foldable sheet 34 (or strip of foldable sheet) of the strip-shaped assembly 32 is arranged inwardly, i.e., toward the base 31. Thanks to this, a uniform outer surface of the baked product that is particularly smooth and easy to decorate can be obtained.

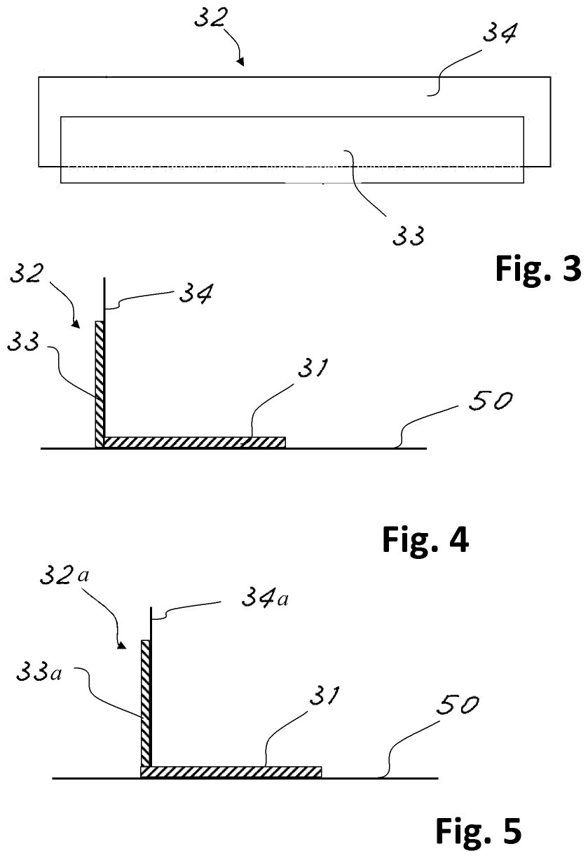

Preferably, in this variant, the foldable sheet 34 may protrude from the strip 33 of dough on a side edge of the strip-shaped assembly 32. This can facilitate the removal of the foldable sheet from the bakery product obtained as a result of baking. In addition, the protruding portion of the foldable sheet may allow two adjacent ends of two strip-shaped assemblies or opposite ends of a single strip-shaped assembly 32 to be fastened, as shown in FIG. 2. Fastening can be done with a staple applied to the protruding part of the foldable sheet. For this purpose, the strip of foldable sheet 34 may be longer than the strip 33 of dough, as shown in FIG. 3.

Preferably, the dough layer 33 protrudes with respect to the foldable sheet along a side edge of the strip-shaped assembly 32, for example by about 0.3 cm to 0.7 cm, preferably by about 0.5 cm.

Preferably, as shown in FIG. 3, the foldable sheet 34 and the layer of dough 33 in a strip-shaped assembly 32 could be offset in a direction orthogonal to the longitudinal extent of the strip-shaped assembly, as well shown in FIG. 3. The dough layer 33 (or strip of dough) of the strip-shaped assembly 32 may rest on a supporting surface 50 which supports the base 31 as well when the strip-shaped assembly 32 is positioned along the edge of the base 31. In this case, the part of the dough layer 33 that protrudes with respect to the foldable sheet 34 is joined to the edge of the base 31 at the face of the dough layer 33 to which the foldable sheet 34 is applied (see FIG. 4).

In the embodiment of FIGS. 2 to 4, the L-shaped supports could not be required even in the case of relatively long rectilinear edges, due to the fact that the foldable sheet 34 can be stapled by its protruding portion and, additionally, because the foldable sheet is arranged inwardly and one or more crumpled sheets can be placed above the base 31 within the edge formed by the strip-shaped assembly 32, so as to hold the strip-shaped assembly 32 in place and prevent it from collapsing inwardly, i.e. toward the base 31.

In a further variant shown in FIG. 5, the dough layer 33a (or strip of dough) of the strip-shaped assembly 32a does not protrude below the foldable sheet 34a (or strip of foldable sheet). In this variant, similarly to the case in FIG. 4, the foldable sheet 34a is arranged facing the base 31. However, the dough layer 33a does not rest on the supporting surface 50, but rather rests on the base 31.

It should be noted that, even in the case of the embodiment of FIG. 1 in which the foldable sheet 14 faces outwardly with respect to the base 11, the layer of dough 13 of the strip-shaped assembly 12 could rest on the base 11 or could also rest on a supporting surface that supports the base 11, one of its side faces being joined to the base 11.

According to a variant of the invention, the strip of dough of the strip-shaped assembly dough could not contact the supporting base, such as a baking tray. In such a case, for example, only the aluminum of the strip-shaped assembly could contact the base.

1. A method for producing a bakery product comprising:
forming a strip-shaped assembly comprising a strip of flour-based dough and a corresponding strip of foldable sheet adhering to the strip of dough, wherein the flour-based dough is suitable to harden after baking;
forming an angle in the range of 70 degrees and 110 degrees between at least at a portion of the strip-shaped assembly and a base by folding and positioning the strip-shaped assembly on the base;
heating in an oven the base and the strip-shaped assembly positioned on the base until the flour-based dough hardens;
removing the strip of foldable sheet from the strip-shaped assembly after heating in the oven.

2. The method according to claim 1, wherein the forming the strip-shaped assembly includes:
applying a layer of a flour-based dough on a foldable sheet;
forming the strip-shaped assembly by cutting the foldable sheet and the dough applied to it.

3. The method according to claim 1 wherein the base comprises a substantially planar base of flour-based dough, wherein after the positioning the strip-shaped assembly on the base, a lateral edge of the strip-shaped assembly is joined to the base of flour-based dough.

4. The method of claim 3 wherein the lateral edge of the strip-shaped assembly is joined to an edge of the base of flour-based dough.

5. The method according to claim 2 wherein before applying the layer of dough on the foldable sheet, the method comprises piercing or embossing the foldable sheet.

6. The method according to claim 1, wherein the strip of dough of the strip-shaped assembly has a thickness between 2 mm and 5 mm.

7. The method according to claim 1, wherein said base of dough comprises at least one curved edge, in edge segments with a radius of curvature greater than 5 cm and longitudinal extension greater than 7 cm, a supporting element with a substantially L-shaped profile is applied to the strip-shaped assembly before heating in order to support the strip-shaped assembly in an inclined position with respect to the base during the heating phase. 8. The method according to claim 7, wherein the strip-shaped assembly is not supported by any further supporting element during the heating phase at segments of the edge of the base with a radius of curvature of less than 5 cm.

8. The method according to claim 2, wherein the foldable sheet is made of aluminum or of paper suitable to withstand a baking process.

9. The method according to claim 3 wherein, when the strip-shaped assembly is positioned along the edge of the base of dough, the strip of foldable sheet of the strip-shaped assembly faces the base of dough and the strip of dough of the strip-shaped assembly faces outside with respect to the base.

10. The method according to claim 2 wherein before applying the dough layer to the foldable sheet, applying a layer of egg white to the foldable sheet so that, after applying the dough layer, the egg white layer is interposed between the foldable sheet and the dough layer.
